(19) United States
(12) Patent Application Publication
(10) Pub. No.: US 2016/0305622 A1
(43) Pub. Date: Oct. 20, 2016

(54) Methodology and Application of technology to keep animal feeding systems running maximum feed availability for the entire crop to grow more evenly and healthily

(71) Applicant: Paul T. Baker, JR., Millsboro, DE (US)

(72) Inventor: Paul T. Baker, JR., Millsboro, DE (US)

(73) Assignee: PAUL TERRANCE BAKER JR., Millsboro, DE (US)

(21) Appl. No.: 14/686,523

(22) Filed: Apr. 14, 2015

(51) Int. Cl. F21S 4/00; F21V 33/00; A01K 39/00

(52) U.S. Cl. CPC F21S 4/007; A01K 39/00; F21V 33/006; F21Y 2113/005

(57) ABSTRACT

The present invention provides a method, wherein a lighting system consisting of a series of LED lights is configured through a feed conveying pan. The conveying pan also known as the “control pan” comprises of a pan and a low voltage LED strip rope light configured normally along the inside of the pan. The LED strand is itself powered by a bulb due to the very low amperage needed to operate it. With the help of a power supply, the LED lights illuminate the control pan causing a sudden interest in the animals to come closer to the control pan. Thus, the control pan gets emptied first ensuring feed availability to the entire house.

### FIELD OF INVENTION

This invention relates to the Methodology and Application of technology to keep animal feeding systems running maximum feed availability for the entire crop to grow more evenly and healthily.

### BACKGROUND ART

Conventional meat poultry are reared in an automated environment with all conditions of their wellbeing controlled by computer systems. Maintaining feed availability to the entire flock consistently through the house is vital in maintain the growth and health of the animals.

Feed is delivered through long tubes (often over 500 ft in length) via an internal screw auger. This system is controlled by a feed pan switch located at the very end of the line; when the feed is removed from this end pan the entire line comes on supplying feed to all the subsequent pans in the house via the auger until the control pan is once again full turning off the line. Because of uneven animal distribution, varied lighting, water availability, temperature variations, and other factors feed pans in the center of the house often become empty before the end “control pan” does, leaving many animals without food until the end pan is eventually emptied.

Other solutions to this problem have been attempted in the past things like split fed housing systems where the food come from 2 different direction limiting the empty pans to half the amount a single line could cause, computer monitoring systems can be purchased so if the feed line motor does not come on within a predetermined length of time the caretaker is notified, and light spiking raising the lighting so the animals become more active and seek still full pans.

### SUMMARY OF INVENTION

The main purpose of the present invention is to provide a novel method of feeding poultry or the like and to keep animal feeding systems running maximum feed availability for the entire crop to grow more evenly and healthily, which can effectively guarantee synchronous feeding and improve the efficiency and quality of feeding.

Another object of the invention is to provide a method which will assure uniform distribution of feed to a large number of chickens or other poultry.

A further object of the invention is to make possible the deposit of feed at a plurality of stations simultaneously, whereby the tendency to crowd or injure weaker poultry away from the feed as deposited is substantially reduced or entirely eliminated.

The simple and effective structure avoid hurt of the poultry. It features both good efficiency and high practical value. The present invention attracts animal through their own natural curiosity and instinct drawing them to the control pan so it is emptied first. This product illuminates the control pan with a series of precisely placed, specifically colored low voltage LED lights. This lighting system is designed specifically for the grow out environment and can be retrofitted to existing systems as well as incorporated into new systems. The amperage required to operate the LED strand is very low, this allows the system to be powered by a bulb outlet and remain very bright even when room lights have been dimmed to 2% of normal illumination (a key product requirement for conventional poultry rearing.)

Animals are drawn to this pan and eat the feed in the illuminated pan much more quickly than in other pans turning the line on ensuring feed availability to the entire house. A 25% increase in run time has been recorded with our product installed in the control pan versus control pans without.

### BRIEF DESCRIPTION OF THE DRAWINGS

FIG. 1. FIG. 1 shows the side view of a typical feed control pan with cut away for illustration.

FIG. 2. FIG. 2 illustrates another typical type of feed control pan but with a top down view to show system placement inside.

FIG. 3. FIG. 3 presents an adaptation method of utilizing the most readily available power supply for ease of implementation into existing grow out systems.

FIG. 4. FIG. 4 presents a top down view of a normal feed delivery system used for animal rearing today.

FIG. 5. FIG. 5 presents a side view of a normal feed delivery system used for animal rearing today.

FIG. 6. FIG. 6 represents the data and graph of the results from a testing of the LED lights against a traditional bulb being hung over the control pan.

### DETAILED DESCRIPTION AND BEST MODE OF IMPLEMENTATION

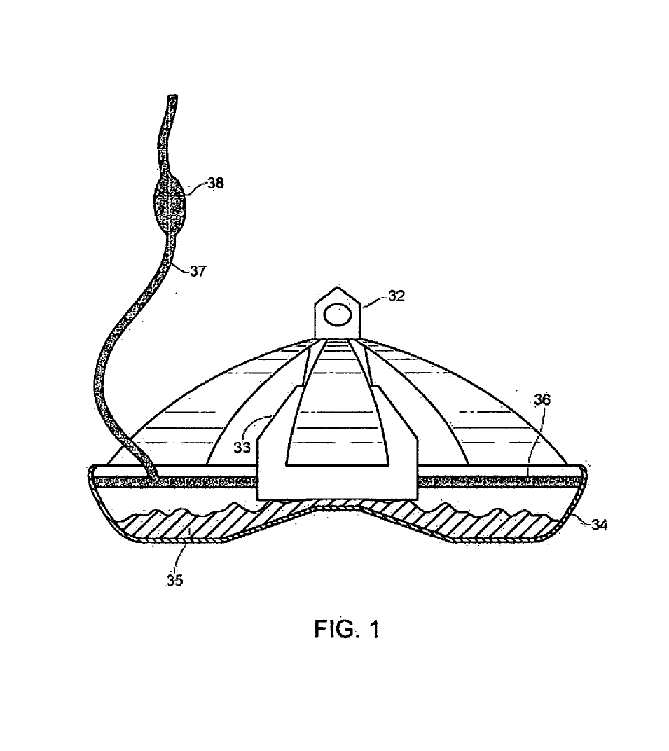

FIG. 1 is representative of a typical feed control pan with a feed delivery line 32 which passes through the opening with a slot for the drop tube 39 which deepens into the control box which houses the control switch 33 feed falls through the control box into the feed pan 34 until the pan is full and feed 35 begins to back up into the control box 33 when enough feed backs up it triggers the control switch which turns off the auger motor 20 stopping feed from moving down the line feed line 13. The low voltage LED strip rope light 36 can be installed into existing feed systems or designed as part of a new system. The low voltage LED strip rope light illuminates the feed in the control pan as long as any lights are on in the house; encouraging birds to consume feed from this before any other pans. The control pan illumination system is enclosed in flexible, and rectangular shaped eco-friendly PVC tube (but not limited to this type of enclosure and systems can be of any shape or rigidity of materials) which is sealed and water tight so the system does not need to be removed during clean out.

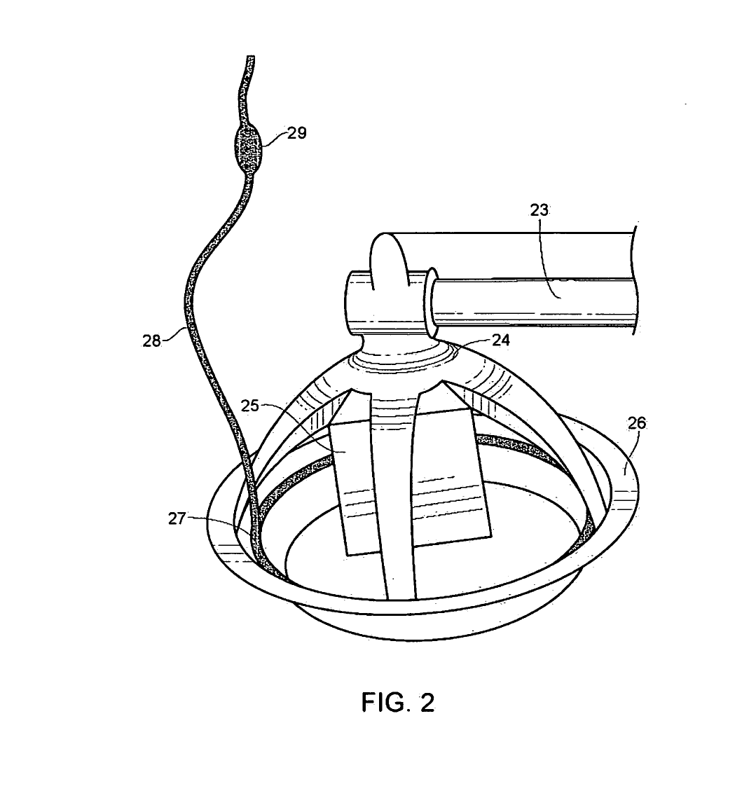

FIG. 2 is a representation of another typical feed control pan with a top down view feed travels down feed tube 23 into the drop tube which is located inside 24 falls in to the control box 25 backing up in the feed pan 26 until it triggers the control switch. The LED light strip rope 27 is typically installed along the inside for the pan just above the feed natural feed fill level but is not limited to this location and can be located anywhere in the control pan; for example under the feed to illuminate it from below, around the control box so it remains if the pan is removed, as well as other locations. Power is supplied the lighting system via he power cable 28 and is conditioned to the proper amperage and voltage in the transformer 29 so power can be supplied by a variety sources.

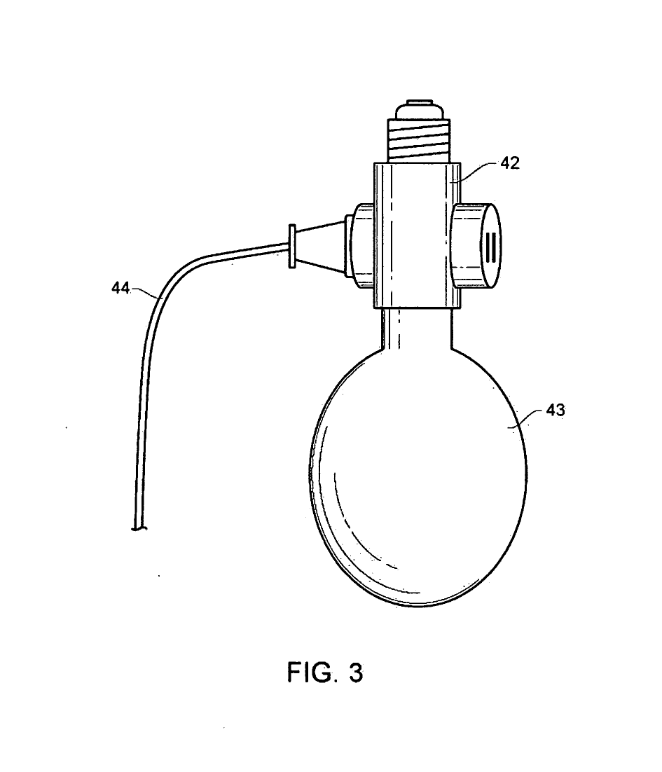

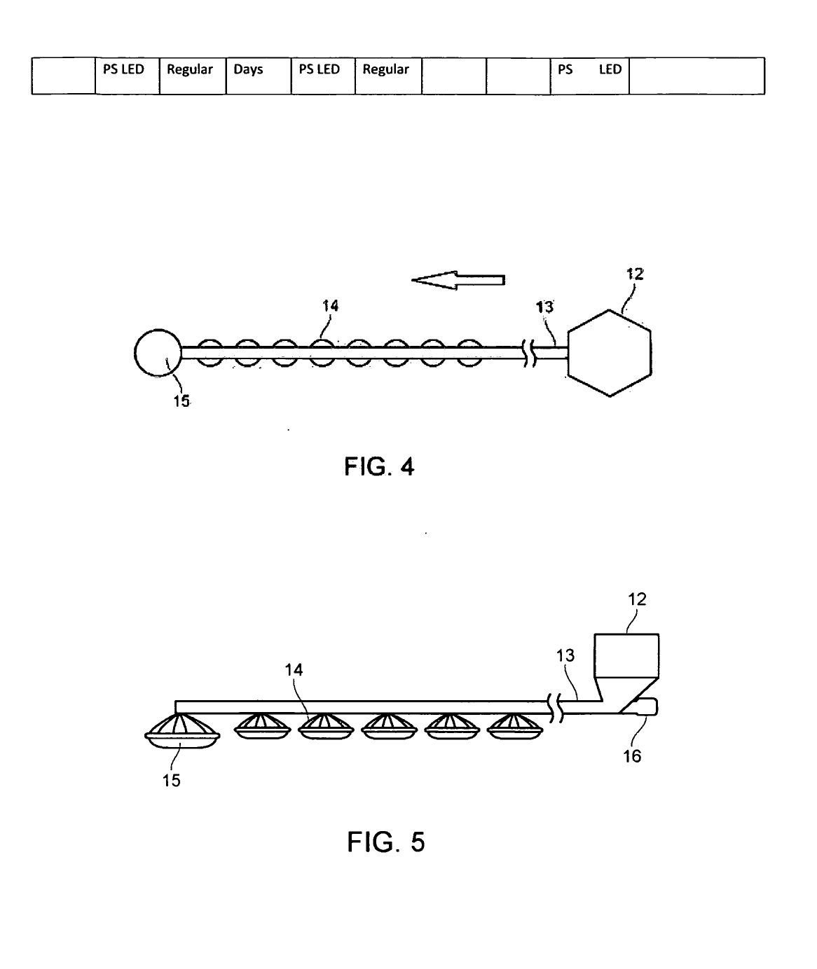

FIG. 3 depicts the recommended power delivery method however the invention is not limited to power delivery via this method, the socket plug adapter 42 is inserted in a light socket allows 2 LED pan light power cables 44 to access power from 1 socket (ideal for split fed houses where 2 separate feed lines come from either side of the house and meet in the center) and a light bulb to still be used to illuminate the area of the house. This LED pan light system utilizes (but is not limited to) 7-9 LM chips which are 2.5 times brighter than typical LEDs at a wattage as low as 4.8 w however they remain illuminates as low as 0.1 w and remain much brighter than house lighting.

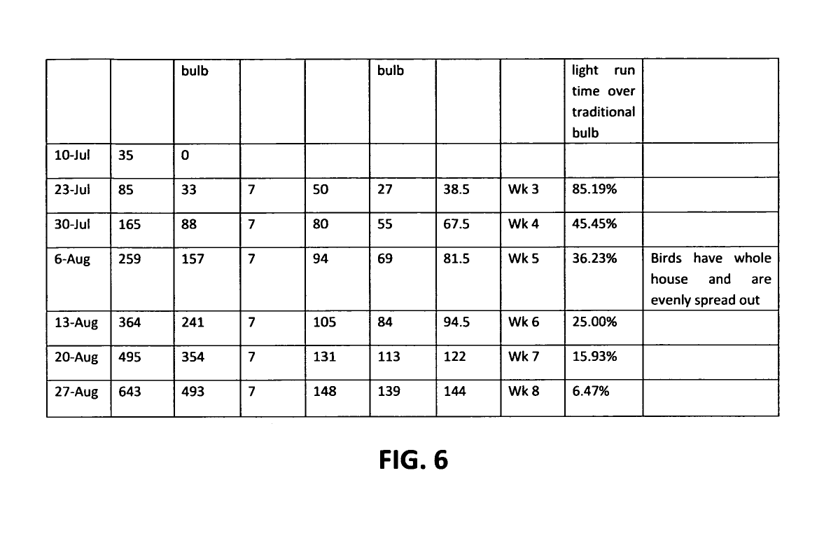

FIG. 6 clearly shows the effectiveness of the LED lights. As the birds get bigger, the available need for food reduces the effectiveness of the pan because there is only enough food for the birds in the house but by that time the job has been done.

We claim:

1. The method of supplying feed to poultry or the like which comprises illuminating the control pan by placing a series of LED lights.

2. The method of supplying feed to poultry or the like which comprises placing the series of LED lights in claim 1 in specific locations to achieve better results.

3. The method of supplying feed to poultry or the like which comprises using specifically colored voltage LED lights.

4. The method of supplying feed to poultry or the like which comprises using specifically a series of low voltage LED lights.

5. The method of supplying feed to poultry or the like using LED strip rope light that can be installed into existing feed systems or designed as part of a new system or feed control pans.
